(19) United States
(12) Patent Application Publication
(10) Pub. No.: US 2020/0211406 A1
(43) Pub. Date: Jul. 2, 2020

(54) MANAGING MULTI-ROLE ACTIVITIES IN A PHYSICAL ROOM WITH MULTIMEDIA COMMUNICATIONS

(71) Applicant: Xio Research, Inc., Nyack, NY (US)

(72) Inventors: RAVINDRANATH KOKKU, Yorktown Heights, NY (US); JIEHUA LI, Highland, MD (US); AMOL NAYATE, Yorktown Heights, NY (US); SATYA V. NITTA, Cross River, NY (US); SEAN O'HARA, Fort Montgomery, NY (US); SHOM PONOTH, Irvine, CA (US); SHARAD SUNDARARAJAN, Union City, NJ (US)

(21) Appl. No.: 16/238,510

(22) Filed: Jan. 2, 2019

(51) Int. Cl. G09B 5/14; G09B 5/06; G09B 5/10

(52) U.S. Cl. CPC G09B 5/14; G08B 3/10; G09B 5/10; G09B 5/065

(57) ABSTRACT

A room and activity management server computer (“server”) and processing methods are disclosed. In some embodiments, the server is programmed to manage multi-role activities collaboratively performed by multiple participants in a physical room with multiple media communications. For each activity, the server is configured to assign roles to participants and enforce rules that govern how the participants in given roles interact with one another or engage with the room at given times. In enforcing the rules, the server is programmed to improve such interaction and engagement through multimedia communications.

### FIELD OF THE DISCLOSURE

One technical field of the present disclosure is facilitating and enhancing user physical activities through digital user interfaces. Another technical field is real-time, intelligent processing and transmission of multimedia communications related to various input and output devices.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Today, computer devices are enabled to regularly interact with humans. Typically, such devices are designed to satisfy individual needs or facilitate user online activities. It would be helpful to have more advanced devices for managing activities collaboratively performed by multiple participant in a physical room, to enhance communication among the participants and engagement with the physical room and provide smooth and enriched user experience to the participants.

### BRIEF DESCRIPTION OF THE DRAWINGS

In the drawings:

FIG. 1 illustrates an example networked computer system in which various embodiments may be practiced.

FIG. 2 illustrates example computer components of a room and activity management server computer in accordance with the disclosed embodiments.

FIG. 3 illustrates an example process performed by the room and activity management server computer of managing multi-role activities in a physical room with multimedia communications.

FIG. 4 illustrates an example process performed by the room and activity management server computer when an action can be inferred from input data.

FIG. 5A illustrates an example process performed by the room and activity management server computer in a first scenario when no action can be inferred from input data.

FIG. 5B illustrates an example process performed by the room and activity management server computer in a second scenario when no action can be inferred from input data.

FIG. 6 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described in sections below according to the following outline:

1. GENERAL OVERVIEW

2. EXAMPLE COMPUTING ENVIRONMENTS

3. EXAMPLE COMPUTER COMPONENTS

4. FUNCTIONAL DESCRIPTIONS

4.1. MANAGING KNOWLEDGE BASES AND RULE SETS

4.2. MANAGING ACTIVITIES IN A PHYSICAL ROOM WITH MULTIMEDIA COMMUNICATIONS

5. EXAMPLE PROCESSES

6. HARDWARE IMPLEMENTATION

7. EXTENSIONS AND ALTERNATIVES

### 1. General Overview

A room and activity management server computer (“server”) and processing methods are disclosed. In some embodiments, the server is programmed to manage multi-role activities collaboratively performed by multiple participants in a physical room with multiple media communications. For each activity, the server is configured to assign roles to participants and enforce rules that govern how the participants in given roles interact with one another or engage with the room at given times. In enforcing the rules, the server is programmed to improve such interaction and engagement through multimedia communications.

In some embodiments, the server is programmed to receive data regarding a physical room, a plurality of participants that may be in the physical room, and a plurality of activities that can be performed in the physical room. The server is programmed to further receive data regarding a plurality of application modes, each corresponding to one of the activities and associated with a set of roles and rules governing how participants in the set of roles can act in the room at given times. For example, the physical room can be a classroom with a podium, a blackboard, and a number of desks and chairs. The participants can include a teacher and twenty students. The activities can include teaching, playing a game, and doing homework. A global rule can be that when a teacher, who is in a higher role, is performing an action, no student, who is in a lower role, can also be performing an action. For the application mode of teaching, a rule can be that only one participant can act at a time. For the application mode of playing a game, the participants can be in the role of a member of a red team or a member of a blue team, and a rule can be that each team needs to stay in the side of the classroom assigned to the team at all times. For the application mode of doing homework, a rule can be that no speaking is allowed unless an approval is received from the teacher.

In some embodiments, the server is located in the physical room and programmed to receive data from one or more input devices also in the physical room. The input devices include sensors, such as cameras or microphones strategically placed throughout the physical room, that capture what is going on in the physical room, including actions performed by the participants, in real time. The server is programmed to enter and exit appropriate application modes according to a specific schedule or in response to specific instructions. For example, the schedule may indicate that the application mode of teaching is effective from 8 am to 8:30 am, the application mode of playing a game is effective from 8:30 am to 8:40 am, and the application mode of doing homework is effective from 8:40 am to 8:50 am. In addition, the server is programmed to continuously receive data generated by the input devices, analyze the data received in a recent window, and determine appropriate actions to perform automatically according to the specific set of rules associated with the current application mode. The determination depends on whether the input data captures specific actions performed by the participants and whether the goals of the actions can be identified, or whether the input data captures what is occurring at a bigger scale, including values of physical attributes of a portion of the room. For example, an action may be speaking a phrase, the goal of the action would be the interpreted meaning of the phrase, and a physical attribute can be the population density, the volume of speech or laughter, or the temperature. The automatic actions may include causing specific participants to interact with certain others or move about in the physical room. For example, the server may be configured to select a student to answer a question from a teacher based on the student's knowledge level and public speaking history or direct students to evacuate the room along specific paths in case of a fire.

In some embodiments, the server is programmed to transmit data to the output devices according to the specific rules of the current application mode. For example, in the application mode of teaching, the data may be transmitted in different forms to all the output devices to enhance the learning experience of the students, in the application mode of playing a game, the data may be broadcast to speakers that is easier to attract the students' attention, while in the application mode of doing homework, the data may be mainly displayed on a common board to minimize diversion of the students' attention from the homework.

The server offers several technical benefits and improvements over past approaches. The server enhances interactive user experience in a physical space by understanding and enforcing a complex set of interaction rules specific to different modes and environments. The server further enhances the interactive user experience by providing real-time, multi-sensory communication and enabling accurate determination of user intent through multiple types of input devices and output devices. Furthermore, the server promotes understanding of and engagement in collaborative activities in the room by participants by automatically providing encouragement, clarification, or supplement through multimedia channels to guide the participants through acting in the room towards the objectives of the collaborative activities. Specifically, the server helps conserve network source utilization and reduce response time as computation and interaction with input and output devices generally takes place directly in the room. The server is efficient in memory usage because the server is designed to actively maintain and analyze only input data received during a relatively short recent period in general and yet is able to capture special moments through detecting the occurrence of special events.

### 2. Example Computing Environments

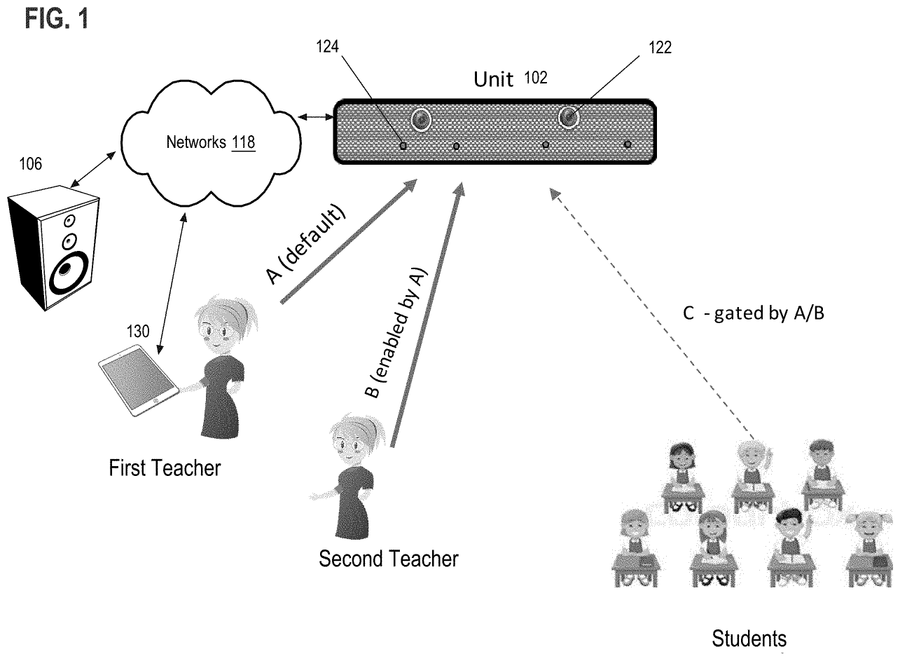

FIG. 1 illustrates an example networked computer system in which various embodiments may be practiced. FIG. 1 is shown in simplified, schematic format for purposes of illustrating a clear example and other embodiments may include more, fewer, or different elements.

In some embodiments, the networked computer system comprises a room and activity management server computer 102 (“server”), one or more client devices 130, and one or more input or output devices 106, which are communicatively coupled directly or indirectly via one or more networks 118.

In some embodiments, the server 102 broadly represents one or more computers, virtual computing instances, and/or instances of a server-based application that is programmed or configured with data structures and/or database records that are arranged to host or execute functions including but not limited to managing multi-role activities in a physical room with multimedia communications. The server 102 is generally located in the room to help achieve real-time response.

In some embodiment, the server 102 is coupled through cables, wires, or other physical components with one or more input or output devices to form an integrated system, to enable the server 102 to communicate with the one or more input or output devices without going through the networks 118. An input device typically includes a sensor to receive data, such as a keyboard to receive tactile signals, a camera to receive visual signals, or a microphone to receive auditory signals. Generally, there can be a sensor to capture or measure any physical attribute of any portion of the room. Additional examples of a physical attribute include smell, temperature, or pressure. An output device is used to produce data, such as a speaker to produce auditory signals, a monitor to produce visual signals, or a heater to produce heat. In this example, the server 102 is coupled with multiple input devices, including a camera 122 and a microphone 124. The integrated device typically enables simultaneous movement of the server 102 and the coupled input or output devices and can be located anywhere in the room, including on the wall or on a desk.

In some embodiments, each of the one or more client devices 130 operated by a participant can be an input device, an output device, or another integrated device programmed to communicate with the server 102 or the input or output devices coupled to the server 102. For example, one of the client devices 130 can be used to submit a request to the server 102 for performing a computational task or for controlling an output device coupled to the server 102. As an integrated device, one of the client devices 130 can be a desktop computer, laptop computer, tablet computer, smartphone, or wearable device. There can generally be any number of client devices in the room. For example, in a classroom with one or more teachers and one or more students, no client device needs to be used at all, or the teacher may be permitted to use one client device, or every participant can be permitted to use a client device at the same time.

In some embodiments, each of the one or more input or output devices 106 is similar to each of the one or more input or output devices that may be coupled to the server 102 in an integrated device except being physically separate from the server 102 and configured to commute with the server 102 through the networks 118. In this example, one of the one or more input or output devices 106 is a speaker. There can generally be any number of such input or output devices in the room, and the number and location of the input or output devices can depend on the size or shape of the room or the number or positions of participants.

The networks 118 may be implemented by any medium or mechanism that provides for the exchange of data between the various elements of FIG. 1. Examples of networks 118 include, without limitation, one or more of a cellular network, communicatively coupled with a data connection to the computing devices over a cellular antenna, a near-field communication (NFC) network, a Local Area Network (LAN), a Wide Area Network (WAN), the Internet, a terrestrial or satellite link, etc.

In some embodiments, the server 102 is programmed to continuously receive data regarding what is happening in the room from the input devices, such as the camera 122, the microphone 124, or the one or more client devices 130. The server 102 is programmed to then interpret the data from the input devices with respect to the current application mode, more specifically any role of a current actor, and any rule associated with the current application mode and applicable to the current actor. Input data received from the input devices or the client devices may be processed differently depending on the sources of the input data. For example, the server 102 may be configured to process communications only from the first teacher, until the first teacher passes the control of communication to the second teacher or approves communications by the students. The server 102 is further programmed to transmit the process or result of the interpretation to the output devices, such as an output device of the one or more client devices 130 or an output device of the one or more input or output devices 106. The transmission generally occurs in real time as soon as the data to be transmitted is available.

### 3. Example Computer Components

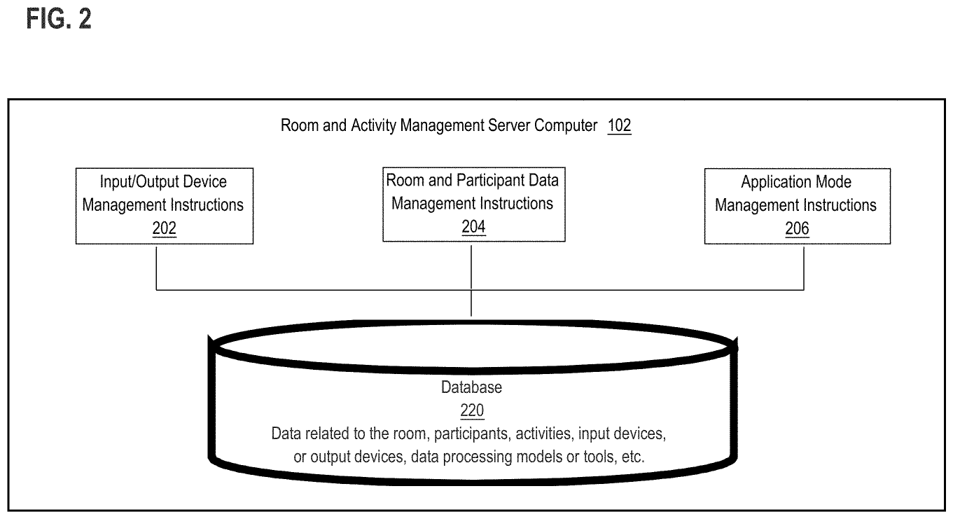

FIG. 2 illustrates example components of the room and activity management server computer in accordance with the disclosed embodiments. This figure is for illustration purposes only and the server 102 can comprise fewer or more functional or storage components. Each of the functional components can be implemented as software components, general or specific-purpose hardware components, firmware components, or any combination thereof. A storage component can be implemented using any of relational databases, object databases, flat file systems, or JSON stores. A storage component can be connected to the functional components locally or through the networks using programmatic calls, remote procedure call (RPC) facilities or a messaging bus. A component may or may not be self-contained. Depending upon implementation-specific or other considerations, the components may be centralized or distributed functionally or physically.

In some embodiments, the server 102 can comprise input/output device management instructions 202, room and participant data management instructions 204, and application mode management instructions 206. In addition, the server 102 can comprise a database 220.

In some embodiments, the input/output device management instructions 202 enable management of and communication with various input devices or output devices. The management may include turning on or shutting off an input or output device, adjusting the sensitivity of an input device, adjusting the intensity of an output device, or coordinating among multiple input and/or output devices. The communication can include receiving data regarding what is happening in the room and conveying the process or result of analyzing the received data back to the room.

In some embodiments, the room and participant data management instructions 204 enable management of data regarding the room and participants in the room. The management of room data, which tends to be static, includes collecting and processing the room data and subsequently applying the room data to determine where the participants are or how the participants should move. The management of participant data includes collecting and processing data regarding participants individually or collectively for identifying the participants and actions performed by the participants and determining any actions to be automatically performed to facilitate the actions being performed or to be performed by the participants.

In some embodiments, the application mode management instructions 206 enable management of application modes, each generally corresponding to a default mode or a specific activity to be carried out in the room and associated with one or more roles and rules, including certain universal roles that can be shared by multiple application modes or certain universal rules that can be applicable to multiple application modes. The management of application modes includes collecting data regarding the application modes, selecting, entering, or exiting an application mode, or applying the data associated with the current application mode. Applying the data associated with the current application mode may include assigning roles to the participants, determining whether actions or goals of the participants satisfy the rules, and identifying any action to perform automatically in response to the determination.

In some embodiments, the database 220 is programmed or configured to manage relevant data structures and store relevant data for functions performed by the server 102. The relevant data may include data related to the room, participants, activities, input devices, output devices, data processing models or tools, and so on. The data related to activities in particular includes data related to corresponding roles and rules. For example, a typical rule indicates that in a specific application mode, a first participant in a specific role is required or disallowed to interact with a second participant by performing a certain action having a certain goal in the room at a certain time.

### 4. Functional Descriptions

### 4.1. Managing Knowledge Bases and Rule Sets

In some embodiments, the server 102 is programmed to receive room data regarding a physical room where multiple participants are to engage in interactive activities. The room data may include a room layout, such as the dimensions of the room or where the walls, doors, or windows are. The room data may also include a furnishing guide. For example, when the room is a classroom, the furnishing guide may indicate where the blackboard or podium is for the teacher and where the desks and chairs are for students. Alternatively, the server 102 can be trained to recognize what the room looks like or has using any object recognition techniques known to someone skilled in the art. The room data may further an evacuation plan, indicating the routes from any point in the room to a safe location inside or outside the room.

In some embodiments, the server 102 is programmed to receive participant data regarding the participants who may participate in activities in the room. The participant data may include the name of each participant and additional multimedia identifiers for each participant, such as a voice sample, a facial or full-body image, or other data having physical descriptions that can be used to recognize a participant in real time. The participant data may also include privacy preferences for how data regarding the participant is collected and used. In addition, the participant data may indicate a universal role in the room for each participant, while an additional role may be assigned to a participant in a specific activity, as further discussed below. For example, in a classroom, each participant may have a role of a teacher or a student, while for a specific activity, the roles of a team leader and a teammate can be assigned to different students each time. The roles are typically hierarchical with higher roles associated with higher precedence or greater permissions. For example, the teacher role is higher than the student role. A general rule associated with universal roles in a classroom can be that when a teacher in the higher role is performing an action, such as speaking, a student in the lower role cannot be performing the action or the action performed by the student is to be ignored. Another general rule can be that only a teacher in the higher role is permitted to interact with the server 102 initially, but all participants are allowed to interact with the server after the first ten minutes of the class.

In some embodiments, the server 102 is programmed to receive activity data regarding the activities the participants in the room are to engage in. The activities may include a default activity corresponding to a default application mode that is effective whenever no specific activity is being carried out in the room. The activity data indicates, for each activity, a basic description, a start time or event and an end time or event, or a set of roles for the participants. The set of roles can also be hierarchical as the universal roles noted above. The activity data can indicate how to assign the set of roles to the participants in the room based on data already available in the database or real-time data regarding participants. For example, in the application mode of playing a game comprising two teams, the students can be added to each team in a way to balance the average heights of the members of two teams. When the game requires the students to form pairs of one storyteller and one listener, the students can be divided into pairs based on certain measures of how much each student knows or likes to talk. The activity data further indicates a set of rules for the activity or with respect to the set of roles that governs how participants in specific roles need to behave individually or with one another in the room, thus associating each of the set of roles with certain permissions or requirements. More specifically, the set of rules can indicate that the participants are supposed to be in specific positions performing specific actions at specific times. The set of rules associated with the set of roles for an activity can generally take precedence over the rules associated with the universal roles. The activity data can also indicate how to process input data from different types of input devices in each activity. For example, for a classroom, the activities can include teaching, playing a game, or doing homework. When the activity is teaching, the relevant rules might include that at most one person can be speaking or moving at a time and there should be no silence for more than five seconds. When the activity is playing a game, the relevant rules may include that there should be two teams standing on two sides of the room during the first five minutes and switching sides in the next five minutes, and the overall activity (sound, light, motion, etc.) level in the room should not exceed a certain threshold. When the activity is doing homework, the relevant rules may include that no one can be changing positions for at least twenty minutes and any student's request to speak is to be approved by a teacher. The activity data can also include a set of universal rules that apply to multiple activities. For example, a universal rule can be that when a participant in a higher role is performing a certain action, a participant in a lower role is forbidden to perform any action without an approval from a participant in that higher role.

In some embodiments, the activity data can indicate, for each activity, which actions to perform automatically and how output data related to the automatic actions is to be produced for different types of output devices. Some automatic actions may be performed in response to an identified action and inferred goal. For example, when the activity is playing a game, and when a team member makes a foul move, a new score for the team can be calculated and data related to the violation including the score can be announced through one or more speakers to more easily attract the teams' attention. When the activity is doing homework, and when a student asks a question that may affect an entire class, an answer to the question can be found from a database and data related to the question including the answer can be displayed through a common screen to minimize diverting the students' attention from the homework.

Some automatic actions may be performed in order to enhance an identified action or the activity overall. In this case, the activity data normally includes keywords and supporting materials related to the activity and requires access to profiles or performance records of one or more participants. The activity data may be related to assisting with understanding of a specific topic and indicate that when the level of performance of a participant is below a certain threshold, certain actions should be performed to overcome or raise the performance level. For example, when a student mentions a concept in a teaching session that is potentially difficult to understand for some other students or when some of the students fail to stay within their assigned positions against the classroom policy, clarifications of the concept or the policy can be announced or displayed. The activity data may also be related to improving engagement in the activities by the participants and similarly indicate that when the level of performance of a participant is below a certain threshold, certain actions should be performed to overcome or raise the performance level. For example, when a teacher is soliciting a certain response and a student has had no recent history of volunteering, a request for the student to participate can be communicated, such as focusing the light on the student. Similarly, when a teacher is requesting students to pair up and some students cannot form pairs, an assignment of pairing can be displayed.

In some embodiments, the server 102 is programmed to receive action data regarding the actions to be performed individually by the participants. The actions may include speaking a phrase, making a gesture, or other physical behavior indicating an intent of the actor. These actions are thus associated with specific goals. Some actions can correspond to issuing commands by the highest role to start or end an activity, such as a teacher announcing to the room that the class (the teaching activity) begins. Some other actions can correspond to issuing commands by a higher role to change permissions associated with the higher role or a lower role, such as a teacher delegating an approval authority to a student leader or disallowing students to interact with the server 102 during the next ten minutes of the class. Some actions can correspond to making requests by any role for permissions to ask questions, such as raising a hand. The sever 102 can be programmed to recognize the actions and infer the corresponding goals using existing techniques known to someone skilled in the art in speech analysis and natural language processing, video analysis and body language processing, or other similar areas.

In some embodiments, the server 102 is programmed to receive room management data for automatically performing specific actions related to background (without specific goals), collective actions performed in any portion of the room. The room management data normally includes a threshold on the value of a physical attribute concerning the room, such as the sound level, lighting, temperature, or motion level. Some room management data may be related to maintaining order and safety of the room. Such room management data may indicate that when the value of a certain physical attribute falls outside the range between the lower threshold and the upper threshold, certain actions should be performed to handle disruptive or dangerous circumstances. For example, when the temperature in the room exceeds a certain threshold indicating a fire within or near the room, directions for participants in the room to move from the current locations to other locations should be displayed. Some room management data may be related to capturing or logging the activities in the room. Such room management data may indicate that when the value of a certain physical attribute exceeds a first threshold and a difference between the value and a current value exceeds a second threshold, certain actions should be performed to preserve memories of the moments occurring in the room. For example, when the population density or amount of laughter in a location within the room suddenly exceeds a certain threshold indicating that some participants might have a precious time together, the moments should be automatically recorded until the value of the certain physical attribute falls below the threshold again.

### 4.2. Managing Activities in a Physical Room with Multimedia Communications

In some embodiments, the server 102 is programmed to follow a schedule of application modes, each corresponding to an activity carried out in the room. For example, one schedule may indicate an application mode of teaching from 9 am to 9:30 am, and an application mode of a team sport from 9:30 am to 10 am. The server 102 is thus programmed to automatically enter and exit an application mode and enforce the rules associated with the application mode or the corresponding activity. Alternatively, the server 102 is programmed to enter or exit an application mode in response to special events or specific instructions received via an input device, such as a microphone or a keyboard. The server 102 can be configured to be in the default application mode whenever no specific application mode is effective.

In some embodiments, the server 102 is programmed to continuously receive multimedia data from various input devices that capture what is happening in the room in real time, identify any action that is to be automatically performed in response to received multimedia, and communicate performance of any automatic action through various output devices. The input devices may include a microphone, a camera, a thermometer, a mouse, a keyboard, or another device that measures a physical aspect of any portion of the room. The output devices may include a screen, a light, a speaker, or another device that communicates information. The received multimedia data can be maintained for a specified period of time to allow for offline training, for example. However, the identification of any action to be automatically performed and determination of how to perform the automatic action is generally made based on the multimedia received during a relatively short recent period of time (“active data”), such as the last 30 seconds, unless certain triggering events occur, as further discussed below. The process or the result of identifying any action to be automatically performed can be communicated through the output devices continuously or according to specific criteria. For example, the server 102 can be configured to cause displaying the words “Listening . . . ” or “Thinking . . . ” by default but cause displaying a continuously increasing reading of a decibel meter to reflect what is happening in the room or playing certain video for ten seconds to divert the attention of the participants in the room and thus change what is happening in the room. The server 102 can be configured to also communicate general, distinct changes in the room, such as the entering or exiting an application mode, the acting of a specific actor in a specific role, or a drastic change in the value of a physical attribute in the room.

In some embodiments, input data received and output data communicated by the server 102 comprises one or more types of data, which can be prioritized in different orders in different application modes. In terms of input data received by the server 102, for example, as a default rule, auditory data indicating speech may carry more weight than visual data indicating gestures in evaluating a participant's action or goal. Therefore, upon detecting a conflict between what a participant says and what the participant signals by hand, the server 102 can be configured to rely on the interpretation of the speech more than the interpretation of the gesture. In the application mode of doing homework, the server 102 can be configured to turn off the recorder or reject any sound data. On the other hand, multiple types of data may be used in combination in interpreting a participant's action or goal. For example, the server 102 can be configured to raise a higher alert upon detecting an unfamiliar face entering the room with threatening speech than detecting a familiar face entering the room with unfriendly speech. In terms of output data communicated by the server 102, for example, a default rule may be to communicate via as many types of output devices as possible. Specific application modes may call for specific priorities. For example, in an application mode of playing a game, due to potential commotion in the room, loud broadcasting to multiple speakers or huge display on a common board may be chosen over the other communication mechanisms, while in an application mode of doing homework, to minimize disruption of participants' attention, more individualized, discreet communication mechanisms may be preferred.

In some embodiments, from the active data, the server 102 is programmed to first determine whether any participant in the room is performing an action, such as speaking a phrase or making a gesture. The speaking of a phrase can be determined by recognizing human voices conveying spoken words using any speech recognition techniques known to someone skilled in the art. The making of a gesture can be determined by recognizing human body parts conveying meaningful motion patterns using any motion detection techniques known to someone skilled in the art.

In some embodiments, upon determining that a participant in the room is performing an action as an actor, the server 102 is programmed to then identify the actor and the role of the actor in the current application mode. As noted above, the server 102 can be configured to match the portion of the active data corresponding to the identified action with identifying data of each participant, such as a voice sample or a facial image. The server 102 can be configured to then use an identifier of the actor to look up the role of the actor in the current application mode. For example, the actor may have a role of a member of the red team in the current application mode of playing a game.

In some embodiments, the active data shows multiple actors performing actions simultaneously. For example, a teacher may be speaking of a painting, while a first student may be asking a question and a second student may be raising a hand. The server 102 is programmed to generally recognize different actions captured by different input devices, such as sounds from the teacher that is captured by a microphone or sights of the second student that is captured by a camera. The server 102 can also be programmed to always try to identify the action of a specific participant or a participant in a specific role using existing natural language processing techniques. For example, there may be at most one of two possible teachers in the room at any time, and the server 102 can be configured to always try to isolate the portion of the active data corresponding to an action performed by either of the two teachers. When the isolation is successful, the server 102 can be programmed to then determine whether another participant in the room is performing an action from the rest of the active data. For example, after isolating the speech of the teacher, the server 102 can be configured to then determine that the first student is also talking.

In some embodiments, the server 102 can be programmed to determine whether any actor is permitted to perform an identified action at this time. Such determination can also be made after the intent or goal of the action is determined, as further described below. In between application modes or in a default application mode, the server 102 can be programmed to check certain default rules. One basic rule may be that a first action of a first actor in a higher role takes precedence over a second action of a second actor in a lower role. For example, when a teacher is speaking, no student should also be speaking. The server 102 can be configured to cause displaying, by a large central screen or a smaller indicator near the location of the second actor, a warning against any actor in the lower role to act at the same time as another actor in the higher role, a demand of the second actor to wait to act until the first actor has completed the first action, or a request for the first actor to approve the second action of the second actor. In a specific application mode, the server 102 can be programmed to check the rules associated with the specific application mode. For example, in the application mode of doing homework, every student needs to stay by his her or desk and no interaction with another student is allowed. The server 102 can be configured to similarly communicate to all participants in the room or to the offending participant what an applicable rule is, how the applicable rule is violated, or how to stop the violation.

In some embodiments, the server 102 is programmed to derive a goal or an intent from an action being performed by an actor. When the action is speaking a phrase, the goal would be what the phrase means or what the actor is trying to achieve by speaking the phrase. Similarly, when the action is making a gesture, the goal would be what the gesture means or what the actor is trying to achieve by making the gesture. As noted above, the server 102 can be configured to match the portion of the active data corresponding to an identified action with certain multimedia deemed to be associated with specific goals using appropriate data processing or analysis techniques known to someone in the art. For example, the spoken words of “may I ask a question”, “can you explain”, or “I don't understand” can all be matched to a goal of raising a question regarding a specific topic. For further example, the gesture of raising a hand can be matched to a goal of a request for permission to ask a question, and the gesture of a lowering head can be matched to a goal of falling asleep. The server 102 can be further programmed to transmit a description of the inferred goal or a request for confirmation of the inferred goal to one or more output devices.

In some embodiments, the server 102 is programmed to then determine whether the actor performing the identified action is permitted to achieve the derived goal at this time, according to further default rules or specific rules associated with specific application modes. For example, certain universal rules may indicate that a participant in a certain role may issue a command to control an input or output device or to enter or exit an application mode. For further example, in an application mode of playing a certain game which divides the students into two teams corresponding to two further roles, a specific rule may be that each member of a team needs to stay on one side of the room assigned to the team, while the teacher can walk around the room without restrictions. Therefore, upon detecting an action of a movement by a member of the first team and a goal of crossing over to the other the side of the room assigned to the second team, the server 102 can be programmed to cause broadcasting a violation of the specific rule and a corresponding deduction of the first team's score, or cause highlighting the current location of the member violating the specific rule and a path back to the side of the room assigned to the first team. Another particular rule may be that participants need to pair up for a discussion. In this case, the server 102 can be configured to determine whether any participant is alone not talking with anyone else, any two participants are sitting together but not talking with each other, or more than two participants are standing together and talking with one another. The determination can focus on whether the participants move their bodies to form pairs and also move their mouths to talk. In response to any positive determination, the server 102 can be programmed to similarly cause broadcasting an automatic assignment of participants who are not in pairs and a reiteration of the requirement for discussion within each pair. In general, the server can be configured to transmit a reason of why the determined goal is not permitted at this time or a request for a participant in a certain role to make an exception to a rule.

In some embodiments, upon determining that the actor performing the identified action is permitted to achieve the derived goal at this time, the server 102 is programmed to determine whether any action should be taken automatically in response to the identified action, according to further default rules or specific rules associated with specific application modes. Such an automatic action typically involves advanced processing beyond simply communicating whether achieving the derived goal is permitted at this time. Generally, when the goal corresponds to a question raised by a first participant, the server 102 can be programmed to look in a database for possible answers or communicate any found answers. For example, in the application mode of teaching, a specific rule may be that in response to a question from a student, an answer is to be found and any answer or the lack thereof is to be communicated to a device accessible to the teacher in real time, while in response to a question from a teacher, an answer is to be found and any answer is to be saved for ten minutes without being reported. When the goal corresponds to an incorrect answer given by a second participant to a question raised by a first participant, the server 102 can be programmed to look in a database for possible hints and communicate any found hints. For example, another specific rule can be that in response to an incorrect answer from a student in response to a question from a teacher, a hint that was effective to a similar group of students is to be found and broadcasted to the room. When the goal corresponds to a statement, the server 102 can be programmed to look in a database for possible definitions or questions (quizzes). For example, another specific rule can be that in response to a statement from a participant that contains one of the keywords that tend to be forgotten or misunderstood by a certain group of participants, a definition of the keyword is to be displayed for fifteen seconds or a question regarding the meaning of the keyword is to be raised to another participant.

In some embodiments, the determined action to be taken automatically by the server 102 may be selecting one or more participants to perform one or more further actions. In response to a question raised by a first participant, a second participant can be selected to answer the question. In response to a statement by a first participant, a second participant can be selected to provide support for the statement, ask a question about the statement, or offer a comment on the statement. In response to an incorrect answer by a first participant, a second participant can be selected to provide a hint to the question or answer the question. The server 102 can be programed to select the one or more participants or the one or more actions randomly or based on one or more weighted factors related to the participants. These factors may include, for one or more participants as a whole, the participation record (e.g., how much a participant has publicly communicated in the room voluntarily or as requested), competence level (e.g., how well a participant has done in homework assignments or tests), apparent disposition (e.g., whether a participant appears to be or is self-identified as being outspoken or shy, calm or nervous under pressure), or development goals (e.g., whether the participant has wished to do more public presentation or focus more in the room). The factors may also include, for one or more participants as a whole, real-time behavior of the participants, such as whether a participant is awake, is focused on the current presenter or presentation, or is having an anxiety attack. For example, a student who has rarely volunteered to perform any action and appears to be drifting off (e.g., head lowering or facing the window, eyes wandering) can be selected, while a student who has correctly answered some questions regarding a topic during the last thirty minutes can be selected to help other students understand difficult concepts related to that topic. Another factor is how much valid data regarding a participant is already available to enable the server 102 to learn as much about as many participants as possible. Yet another factor is where a participant is located or what the participant's role is. For example, it may be desirable to improve participation from students sitting further away from the teacher, or balance participation between two teams within the room.

In some embodiments, when no intent or goal can be derived from the identified action, the server 102 can be programmed to communicate a reason for failing to infer any goal or a request for carefully repeating the action. For example, the actor might have spoken too fast or too loudly, and a message of repeating what was said slowly or in a lower volume can be displayed. The server 102 can also be programmed to communicate a request for performing another action to achieve the same goal. For example, an actor might have suddenly stood up without saying a word. A message indicating a lack of understanding of the performed action and a request for the actor to convey the goal in alternative ways can be announced.

In some embodiments, when no specific action can be identified, the server 102 is programmed to check the default rules or specific rules associated with specific application modes. As noted above, each application mode can be associated with a lower threshold and an upper threshold for each of various physical attributes of at least a portion of the room, such as volume, density, amount of movement, temperature, lighting level, odor level, or pressure level. The server 102 can be programmed to determine whether the value of the physical attribute falls within the range between the lower threshold and the upper threshold. The server 102 can be further programmed to take specific actions depending on the group of participants or past experiences. For example, when the room becomes too noisy for the specific application mode, the server 102 can be configured to cause broadcasting a demand of every participant in the room to lower their voice level, playing calming, soothing sounds to help the participants settle down, or displaying some interesting visuals to stop the participants from what they were originally doing. When the room becomes too quiet for the specific application mode, the server 102 can be configured to cause displaying a joke or displaying both a question and a real-time video of a particular participant to prompt the participant to answer the question. The joke can be selected based on past response to the joke in another room or from another group of similar participants, and the question and the particular participant to answer the question can be selected based on the average knowledge level of the participants and the participation record of the particular participant. In addition, when the room does not have all the participants required to be in attendance, the server 102 can be configured to communicate the names of the missing participants to a device of a participant in the highest role or transmitting a question of where a missing participant might be to a particular participant in attendance, such as the participant who typically sits next to the missing participant in the room. When someone who is not expected to be attendance shows up in the room, the serer 102 can be configured to cause broadcasting a request for the person to identify himself or herself or exit the room or an instruction for the existing participants to retreat to specific corners or exits of the room.

In some embodiments, when no specific action can be identified, the server 102 is programmed to check the default rules or specific rules associated with specific application modes to detect occurrence of additional triggering events. Such a triggering event often involves a sudden, drastic change of a value of a physical attribute of at least a portion of a room, especially when the changed value falls outside the normal range for the physical attribute. One triggering event causes continuous recording (beyond the default period) of received multimedia data until the triggering event is over or until the room is back to how it was before the triggering event. The purpose of such a triggering event is to save special moments. Such a triggering event can be in the form of celebratory sounds (e.g., music, singing, laughter, applaud, etc.) hitting a certain volume, clustering of faces, completely turning off the lights, or appearance of an unexpected person or object. The triggering event may also cause communication of a notification to a participant in the highest role in the specification application mode or other guards or government authorities outside the room.

In some embodiments, the server 102 is programmed to use the received multimedia data for further learning subject to specific privacy preferences noted above. The server 102 can be configured to use the received multimedia data in an aggregate manner to train models for recognizing global features, such as general pronunciation of certain words, laughter, phrasing of questions, or average response time over all students. The server 102 can also be configured to use the received multimedia data on an individual basis. The action performed by an actor can be used to identify or describe the actor. For example, initially, the actor may be identified by the voice sample or facial image originally provided by the actor, and the actor's speech in the current action is saved. At a later time, the actor may be identified by the stored speech together with the voice sample, which may render the identification more accurate, and a photo of the actor performing the current action can be saved, which enables recognition of the actor even when the appearance or posture of the actor changes over time. In addition, the goal or intent inferred from the action can be used to gauge performance of the actor. Specifically, when certain words or concepts are tagged with difficulty levels, the actor's ability or inability to use those words or apply those concepts in raising questions, making statements, or answering questions can be recorded and used to determine how to automatically interact with the actor in the future.

### 5. Example Processes

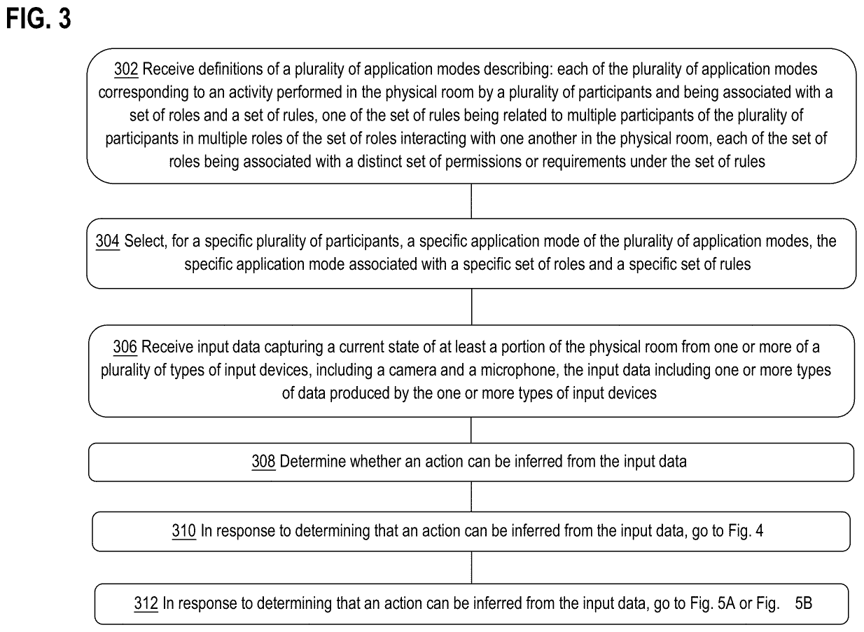

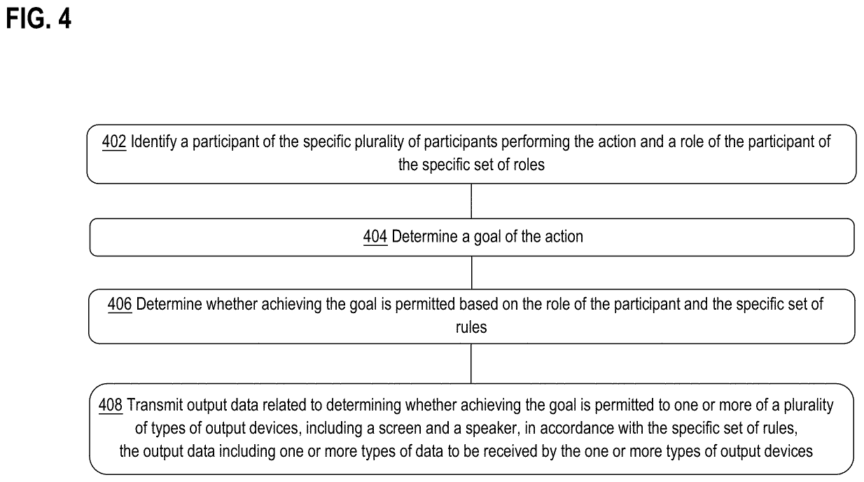

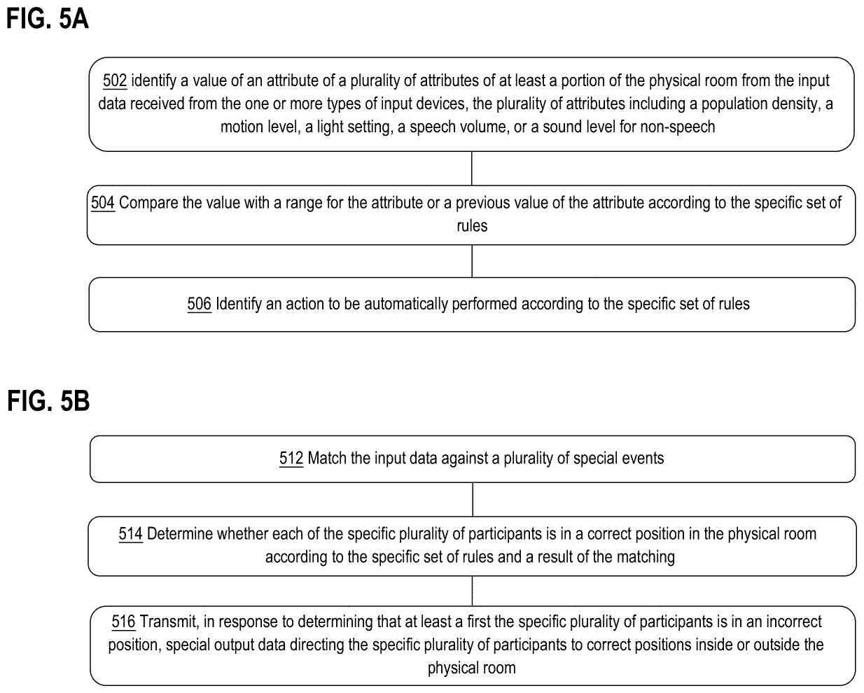

FIG. 3, FIG. 4, FIG. 5A, and FIG. 5B discussed below are shown in simplified, schematic format for purposes of illustrating a clear example and other embodiments may include more, fewer, or different elements connected in various manners. FIG. 3, FIG. 4, FIG. 5A, and FIG. 5B are intended to disclose an algorithm, plan or outline that can be used to implement one or more computer programs or other software elements which when executed cause performing the functional improvements and technical advances that are described herein. Furthermore, the flow diagrams herein are described at the same level of detail that persons of ordinary skill in the art ordinarily use to communicate with one another about algorithms, plans, or specifications forming a basis of software programs that they plan to code or implement using their accumulated skill and knowledge.

FIG. 3 illustrates an example process performed by the room and activity management server computer of managing multi-role activities in a physical room with multimedia communications.

In some embodiments, in step 302, the server 102 is programmed to receive definitions of a plurality of application modes. The definitions may describe that each of the plurality of application modes corresponding to an activity performed in the physical room by a plurality of participants and being associated with a set of roles and a set of rules. The definitions may further describe one of the set of rules being related to multiple participants of the plurality of participants in multiple roles of the set of roles interacting with one another in the physical room, and each of the set of roles being associated with a distinct set of permissions or requirements under the set of rules. The plurality of application modes may include a teaching mode associated with a rule that precisely one participant is permitted to act at a time, a game mode associated with a first set of hierarchical roles and a rule that multiple participants are permitted to act at a time when a participant in a higher role of the first set of hierarchical roles is not acting, or a working mode associated with a second set of hierarchical roles and a rule that a participant is not permitted to perform a certain action until a confirmation is received from a participant in a higher role of the second set of hierarchical roles.

In some embodiments, in step 304, the server 102 is programmed to select, for a specific plurality of participants, a specific application mode of the plurality of application modes, the specific application mode associated with a specific set of roles and a specific set of rules. The selection may be according to a specific schedule, in response to a triggering event, or upon a specific participant request.

In some embodiments, in step 306, the server 102 is programmed to receive input data capturing a current state of at least a portion of the physical room from one or more of a plurality of types of input devices, where the input data includes one or more types of data produced by the one or more types of input devices. The plurality of types of input devices can include a camera or a microphone, a keyboard, a mouse, a smoke detector, or a thermostat.

In some embodiments, in step 308, the server 102 is programmed to determine whether an action can be inferred from the input data. The action can include laughing, speaking a phrase, making a gesture, or changing locations. The determining can comprise inferring multiple actions simultaneously performed by multiple participants from the input data, including a first action performed by a first participant and a second action performed by a second participant. In this case, the output data can confirm the first action or requiring the second participant to wait as the first participant repeats the first action. Specifically, the first participant can be in a higher role than the second participant, inference of the first action can be associated with a higher confidence score than an inference of the second action, or a first type of input device producing a first portion of the input data from which the first action is inferred can be associated with a higher priority than a second type of input device producing a second portion of the input data from which the second action is inferred.

In some embodiments, in step 310, in response to determining that an action can be inferred from the input data, the server 102 is programmed to perform the steps described in FIG. 4. In step 312, in response to determining that no action can be inferred from the input data, the server 102 is programmed to perform the steps described in FIG. 5A or FIG. 5B.

FIG. 4 illustrates an example process performed by the room and activity management server computer when an action can be inferred from input data.

In some embodiments, in step 402, the server 102 is programmed to identify a participant of the specific plurality of participants performing the action and a role of the participant of the specific set of roles. The identification of the participant can be based on participant already available in the database, such as a voice sample or a facial image.

In some embodiments, in step 404, the server 102 is programmed to determine a goal of the action. The determination of the goal can be made using existing data analysis techniques, such as speech and natural language processing or image processing and classification.

In some embodiments, in step 406, the server 102 is programmed to determine whether achieving the goal is permitted based on the role of the participant and the specific set of rules. In step 408, the server 102 is programmed to transmit output data related to determining whether achieving the goal is permitted to one or more of a plurality of types of output devices in accordance with the specific set of rules, where the output data includes one or more types of data to be received by the one or more types of output devices. The plurality of types of output devices can include a screen, a speaker, or an air conditioner.

In some embodiments, in response to determining that achieving the goal is not permitted, the output data can direct a denial of the goal for lacking a permission, a reason for lacking the permission, or a recommendation for obtaining the permission to the participant or directing a request for special permission to a second participant of the specific plurality of participants in a second role of the specific set of roles. In response to determining that the goal is permitted, the server 102 is further programmed to perform the following steps. When the goal corresponds to a question, the server 102 is further programmed to determine whether an answer to the question can be found from a database, with the output data including the answer. When the goal corresponds to a statement, the server 102 is further programmed to determine whether a supporting statement or a related question for the statement can be found from the database, with the output data including the supporting statement or the related question. When the goal corresponds to an incorrect answer to a certain question to which a previous goal corresponds, the server 102 is further programmed to determine whether a hint to the certain question can be found from the database, the output data including the hint. In addition, in response to determining that the goal is permitted and that a certain participant of the specific plurality of participants is to be selected to perform an action related to the goal, the server 102 is further programmed to select the certain participant based on amount of data available in the database regarding the specific plurality of participants, recent histories of public communication in the room of the specific plurality of participants, a current state of the specific plurality of participants in the room, or a current status of the application mode.

FIG. 5A illustrates an example process performed by the room and activity management server computer in a first scenario when no action can be inferred from input data.

In some embodiments, in step 502, the server 102 is programmed to identify a value of an attribute of a plurality of attributes of at least a portion of the physical room from the input data received from the one or more types of input devices. The plurality of attributes can include a population density, a motion level, a light setting, a speech volume, or a sound level for non-speech.

In some embodiments, in step 504, the server 102 is programmed to compare the value with a range for the attribute or a previous value of the attribute according to the specific set of rules. In some embodiments, in step 506, the server 102 is programmed to identify an action to be automatically performed according to the specific set of rules.

In some embodiments, in steps 504 and 506, the server is further programmed to determine whether the value is above a first threshold or below a second threshold for the attribute based on the specific set of rules, with the output data requiring participants to weaken their actions when in response to determining that the value is above the first threshold, and with the output data encouraging the participants to strength their actions in response to determining that the value is below the second threshold.

In some embodiments, in steps 504 and 506, the server is further programmed to turn on continuous storage of the input data without removal in response to determining that the value satisfying a criterion of falling outside a certain range for the attribute and having a difference from a previous value of the attribute that exceeds a certain threshold or detecting an appearance of an object that cannot be identified or having a type of a plurality of types in the input data, turning on continuous storage of the input data without removal. The server is alternatively programmed to turn off the continuous storage in response to determining that the value no longer satisfies the criterion or detecting a disappearance of the object.

FIG. 5B illustrates an example process performed by the room and activity management server computer in a second scenario when no action can be inferred from input data.

In some embodiments, in step 512, the server 102 is programmed to match the input data against a plurality of special events. The special event can be the sounding of an alarm for a beginning of end of an application mode or for an emergency or the appearance of an unexpected object.

In some embodiments, in step 514, the server 102 is programmed to determine whether each of the specific plurality of participants is in a correct position in the physical room according to the specific set of rules and a result of the matching.

In some embodiments, in step 516, the server 102 is programmed to transmit, in response to determining that at least a first the specific plurality of participants is in an incorrect position, special output data directing the specific plurality of participants to correct positions inside or outside the physical room. The special output data can be a request for a second participant of the specific plurality of participants positioned next to the first participant in the room to assist in getting the first participant to the correct position.

### 6. Hardware Implementation

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

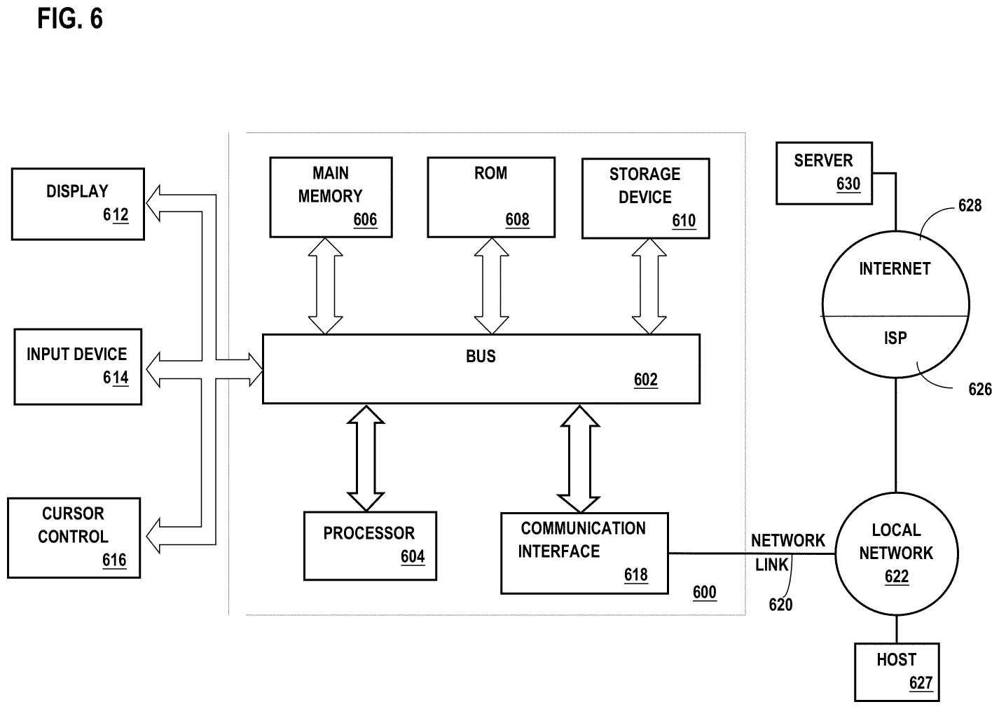

FIG. 6 is a block diagram that illustrates an example computer system with which an embodiment may be implemented. In the example of FIG. 6, a computer system 600 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 600 includes an input/output (I/O) subsystem 602 which may include a bus and/or other communication mechanism(s) for communicating information and/or instructions between the components of the computer system 600 over electronic signal paths. The I/O subsystem 602 may include an I/O controller, a memory controller and at least one I/O port. The electronic signal paths are represented schematically in the drawings, for example as lines, unidirectional arrows, or bidirectional arrows.

At least one hardware processor 604 is coupled to I/O subsystem 602 for processing information and instructions. Hardware processor 604 may include, for example, a general-purpose microprocessor or microcontroller and/or a special-purpose microprocessor such as an embedded system or a graphics processing unit (GPU) or a digital signal processor or ARM processor. Processor 604 may comprise an integrated arithmetic logic unit (ALU) or may be coupled to a separate ALU.

Computer system 600 includes one or more units of memory 606, such as a main memory, which is coupled to I/O subsystem 602 for electronically digitally storing data and instructions to be executed by processor 604. Memory 606 may include volatile memory such as various forms of random-access memory (RAM) or other dynamic storage device. Memory 606 also may be used for storing temporary variables or other intermediate information during execution of instructions to be executed by processor 604. Such instructions, when stored in non-transitory computer-readable storage media accessible to processor 604, can render computer system 600 into a special-purpose machine that is customized to perform the operations specified in the instructions.

Computer system 600 further includes non-volatile memory such as read only memory (ROM) 608 or other static storage device coupled to I/O subsystem 602 for storing information and instructions for processor 604. The ROM 608 may include various forms of programmable ROM (PROM) such as erasable PROM (EPROM) or electrically erasable PROM (EEPROM). A unit of persistent storage 610 may include various forms of non-volatile RAM (NVRAM), such as FLASH memory, or solid-state storage, magnetic disk or optical disk such as CD-ROM or DVD-ROM, and may be coupled to I/O subsystem 602 for storing information and instructions. Storage 610 is an example of a non-transitory computer-readable medium that may be used to store instructions and data which when executed by the processor 604 cause performing computer-implemented methods to execute the techniques herein.

The instructions in memory 606, ROM 608 or storage 610 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file processing instructions to interpret and render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 600 may be coupled via I/O subsystem 602 to at least one output device 612. In one embodiment, output device 612 is a digital computer display. Examples of a display that may be used in various embodiments include a touch screen display or a light-emitting diode (LED) display or a liquid crystal display (LCD) or an e-paper display. Computer system 600 may include other type(s) of output devices 612, alternatively or in addition to a display device. Examples of other output devices 612 include printers, ticket printers, plotters, projectors, sound cards or video cards, speakers, buzzers or piezoelectric devices or other audible devices, lamps or LED or LCD indicators, haptic devices, actuators or servos.

At least one input device 614 is coupled to I/O subsystem 602 for communicating signals, data, command selections or gestures to processor 604. Examples of input devices 614 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 616, which may perform cursor control or other automated control functions such as navigation in a graphical interface on a display screen, alternatively or in addition to input functions. Control device 616 may be a touchpad, a mouse, a trackball, or cursor direction keys for communicating direction information and command selections to processor 604 and for controlling cursor movement on display 612. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 614 may include a combination of multiple different input devices, such as a video camera and a depth sensor.

In another embodiment, computer system 600 may comprise an internet of things (IoT) device in which one or more of the output device 612, input device 614, and control device 616 are omitted. Or, in such an embodiment, the input device 614 may comprise one or more cameras, motion detectors, thermometers, microphones, seismic detectors, other sensors or detectors, measurement devices or encoders and the output device 612 may comprise a special-purpose display such as a single-line LED or LCD display, one or more indicators, a display panel, a meter, a valve, a solenoid, an actuator or a servo.

When computer system 600 is a mobile computing device, input device 614 may comprise a global positioning system (GPS) receiver coupled to a GPS module that is capable of triangulating to a plurality of GPS satellites, determining and generating geo-location or position data such as latitude-longitude values for a geophysical location of the computer system 600. Output device 612 may include hardware, software, firmware and interfaces for generating position reporting packets, notifications, pulse or heartbeat signals, or other recurring data transmissions that specify a position of the computer system 600, alone or in combination with other application-specific data, directed toward host 624 or server 630.

Computer system 600 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 600 in response to processor 604 executing at least one sequence of at least one instruction contained in main memory 606. Such instructions may be read into main memory 606 from another storage medium, such as storage 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 610. Volatile media includes dynamic memory, such as memory 606. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 602. Transmission media can also take the form of acoustic or light waves, such as those generated during radio-wave and infra-red data communications.

Various forms of media may be involved in carrying at least one sequence of at least one instruction to processor 604 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 600 can receive the data on the communication link and convert the data to be read by computer system 600. For instance, a receiver such as a radio frequency antenna or an infrared detector can receive the data carried in a wireless or optical signal and appropriate circuitry can provide the data to I/O subsystem 602 such as place the data on a bus. I/O subsystem 602 carries the data to memory 606, from which processor 604 retrieves and executes the instructions. The instructions received by memory 606 may optionally be stored on storage 610 either before or after execution by processor 604.

Computer system 600 also includes a communication interface 618 coupled to bus 602. Communication interface 618 provides a two-way data communication coupling to network link(s) 620 that are directly or indirectly connected to at least one communication networks, such as a network 622 or a public or private cloud on the Internet. For example, communication interface 618 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 622 broadly represents a local area network (LAN), wide-area network (WAN), campus network, internetwork or any combination thereof. Communication interface 618 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 618 sends and receives electrical, electromagnetic or optical signals over signal paths that carry digital data streams representing various types of information.

Network link 620 typically provides electrical, electromagnetic, or optical data communication directly or through at least one network to other data devices, using, for example, satellite, cellular, Wi-Fi, or BLUETOOTH technology. For example, network link 620 may provide a connection through a network 622 to a host computer 624.

Furthermore, network link 620 may provide a connection through network 622 or to other computing devices via internetworking devices and/or computers that are operated by an Internet Service Provider (ISP) 626. ISP 626 provides data communication services through a world-wide packet data communication network represented as internet 628. A server computer 630 may be coupled to internet 628. Server 630 broadly represents any computer, data center, virtual machine or virtual computing instance with or without a hypervisor, or computer executing a containerized program system such as DOCKER or KUBERNETES. Server 630 may represent an electronic digital service that is implemented using more than one computer or instance and that is accessed and used by transmitting web services requests, uniform resource locator (URL) strings with parameters in HTTP payloads, API calls, app services calls, or other service calls. Computer system 600 and server 630 may form elements of a distributed computing system that includes other computers, a processing cluster, server farm or other organization of computers that cooperate to perform tasks or execute applications or services. Server 630 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to interpret or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 630 may comprise a web application server that hosts a presentation layer, application layer and data storage layer such as a relational database system using structured query language (SQL) or no SQL, an object store, a graph database, a flat file system or other data storage.

Computer system 600 can send messages and receive data and instructions, including program code, through the network(s), network link 620 and communication interface 618. In the Internet example, a server 630 might transmit a requested code for an application program through Internet 628, ISP 626, local network 622 and communication interface 618. The received code may be executed by processor 604 as it is received, and/or stored in storage 610, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 604. While each processor 604 or core of the processor executes a single task at a time, computer system 600 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

### 7.0. Extensions and Alternatives

In the foregoing specification, embodiments of the disclosure have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction

1. A system for managing multi-role activities in a physical room with multimedia communications, comprising:
one or more processors;
at least one memory storing computer-executable instructions which when executed cause the one or more processors to perform:
receiving definitions of a plurality of application modes describing:
each of the plurality of application modes corresponding to an activity performed in the physical room by a plurality of participants and being associated with a set of roles and a set of rules,
one of the set of rules being related to multiple participants of the plurality of participants in multiple roles of the set of roles interacting with one another in the physical room,
each of the set of roles being associated with a distinct set of permissions or requirements under the set of rules;
selecting, by the processor, for a specific plurality of participants, a specific application mode of the plurality of application modes, the specific application mode associated with a specific set of roles and a specific set of rules;
receiving, in real time, input data capturing a current state of at least a portion of the physical room from one or more of a plurality of types of input devices in the physical room, including a camera and a microphone,
the input data including one or more types of data produced by the one or more types of input devices;
determining whether an action can be inferred from the input data using natural language processing, video analysis, or other machine learning techniques; and
in response to determining that an action can be inferred from the input data:
identifying multiple actions simultaneously performed by multiple participants from the input data, including a first action performed by a first participant and a second action performed by a second participant;
determining the first participant being in a higher role than the second participant, inference of the first action being associated with a higher confidence score than an inference of the second action, or a first type of input device producing a first portion of the input data from which the first action is inferred being associated with a higher priority than a second type of input device producing a second portion of the input data from which the second action is inferred:
determining a goal of the first action using natural language processing, video analysis, or other machine learning techniques;
determining whether achieving the goal is permitted based on the role of the first participant and the specific set of rules; and
transmitting, in real time, output data related to determining whether achieving the goal is permitted to one or more of a plurality of types of output devices in the physical room, including a screen and a speaker, in accordance with the specific set of rules,
the output data confirming the first action or requiring the second participant to wait as the first participant repeats the first action,
the output data including one or more types of data to be received by the one or more types of output devices.

2. The system of claim 1, the plurality of application modes including:
a teaching mode associated with a rule that precisely one participant is permitted to act at a time,
a game mode associated with a first set of hierarchical roles and a rule that multiple participants are permitted to act at a time when a participant in a higher role of the first set of hierarchical roles is not acting, or
a working mode associated with a second set of hierarchical roles and a rule that a participant is not permitted to perform a certain action until a confirmation is received from a participant in a higher role of the second set of hierarchical roles.

3. The system of claim 1, the action being speaking a phrase, making a gesture, or providing other input through an input device.

4. (canceled)

5. The system of claim 1, in response to determining that achieving the goal is not permitted, the output data directing a denial of the goal for lacking a permission, a reason for lacking the permission, or a recommendation for obtaining the permission to the participant or directing a request for special permission to a second participant of the specific plurality of participants in a second role of the specific set of roles.

6. The system of claim 1, the computer-executable instructions when executed causing the one or more processors to further perform: in response to determining that the goal is permitted:
when the goal corresponds to a question, determining whether an answer to the question can be found from a database, the output data including the answer;
when the goal corresponds to a statement, determining whether a supporting statement or a related question for the statement can be found from the database, the output data including the supporting statement or the related question;
when the goal corresponds to an incorrect answer to a certain question to which a previous goal corresponds, determining whether a hint to the certain question can be found from the database, the output data including the hint.

7. The system of claim 6, when the goal corresponds to a question,
when the question is directed to a second participant of the specific plurality of participants in a higher role of the specific set of roles than the participant, the output data including the answer being transmitted to a device associated with the second participant,
when the question is directed to a third participant of the specific plurality of participants in a lower role of the specific set of roles than the participant, determining whether an answer can be found from the database comprising selecting a certain participant in the lower role based on profiles of the specific plurality of participants in the database.

8. The system of claim 6, when the goal corresponds to a statement, determining whether a related question for the statement can be found from the database comprising:
identifying one or more words from the statement that are deemed to exceed an aggregate comprehension level of the specific plurality of participants based on prior association of the specific plurality of participants and a plurality of dictionary words with different comprehension levels;
formulating the related question around the one or more words.

9. The system of claim 6, when the goal corresponds to an incorrect answer to a certain question to which a previous goal corresponds, determining whether a hint to the certain question can be found from the database comprising selecting a second participant of the specific plurality of participants based on profiles of the specific plurality of participants in the database.

10. The system of claim 1, the computer-executable instructions when executed causing the one or more processors to further perform: in response to determining that the goal is permitted, when the goal corresponds to an instruction to change a specific permission of the set of permissions associated with a specific role of the set of roles, updating the set of permissions associated with the specific role according to the instruction.

11. The system of claim 1, the computer-executable instructions when executed causing the one or more processors to further perform: in response to determining that the goal is permitted and that a certain participant of the specific plurality of participants is to be selected to perform an action related to the goal, selecting the certain participant based on amount of data available in the database regarding the specific plurality of participants, recent histories of public communication in the room of the specific plurality of participants, a current state of the specific plurality of participants in the room, or a current status of the application mode.

12. The system of claim 1, the computer-executable instructions when executed causing the one or more processors to further perform:
receiving additional input data, the additional input data capturing a current state of at least a portion of the physical room from one or more of the plurality of physical input devices;
determining that no action can be inferred from the additional input data;
identifying a value of an attribute of a plurality of attributes of at least a portion of the physical room from the additional input data received from the one or more types of input devices,
the plurality of attributes including a population density, a motion level, a light setting, a speech volume, or a sound level for non-speech;
determining whether the value is above a first threshold or below a second threshold for the attribute based on the specific set of rules,
transmitting additional output data requiring participants to weaken or strengthen their actions depending on whether the value is above or below the first threshold.

13. The system of claim 1, the computer-executable instructions when executed causing the one or more processors to further perform:
receiving additional input data, the additional input data capturing a current state of at least a portion of the physical room from one or more of the plurality of physical input devices;
determining that no action can be inferred from the additional input data;
identifying a value of an attribute of a plurality of attributes of at least a portion of the physical room from the input data received from the one or more types of input devices,
the plurality of attributes including a population density, a motion level, a light setting, a speech volume, or a sound level for non-speech;
in response to determining that the value satisfying a criterion of falling outside a certain range for the attribute and having a difference from a previous value of the attribute that exceeds a certain threshold or detecting an appearance of an object that cannot be identified or having a type of a plurality of types in the input data, turning on continuous storage of the input data without removal;
in response to determining that the value no longer satisfies the criterion or detecting a disappearance of the object, turning off the continuous storage.

14. The system of claim 13, the computer-executable instructions when executed causing the one or more processors to further perform: in response to determining that the value satisfying a criterion of falling outside a certain range for the attribute and having a difference from a previous value of the attribute that exceeds a certain threshold or detecting an appearance of an object that cannot be identified or having a type of a plurality of types in the input data, sending a notification to a device of one of the specific participants in a highest role of the specific set of roles that also includes at least one lower role.

15. The system of claim 1, the computer-executable instructions when executed causing the one or more processors to further perform: in response to determining that no action can be inferred from the input data or after identifying a participant of the specific plurality of participants performing the action and a role of the participant of the specific set of roles:
matching the input data against a plurality of special events;
determining whether each of the specific plurality of participants is in a correct position in the physical room according to the specific set of rules and a result of the matching;
in response to determining that at least a first the specific plurality of participants is in an incorrect position, transmitting special output data directing the specific plurality of participants to correct positions inside or outside the physical room.

16. The system of claim 15,
the special event being an alarm for a beginning of end of an application mode or for an emergency,
the special output data including a request for a second participant of the specific plurality of participants positioned next to the first participant in the room to assist in getting the first participant to the correct position.

17. The system of claim 1,
the input data including multiple types of data produced by multiple types of input devices associated with corresponding priorities,
determining a goal of the action comprising:
deriving a sub-goal from each of the multiple types of data;
identifying the goal from the multiple sub-goals based on the corresponding priorities.

18. The system of claim 1, the computer-executable instructions when executed causing the one or more processors to further perform:
determining a current state of each of the specific plurality of participants in the room;
assigning the specific set of roles to the specific plurality of participants based on at least the current state of each of the plurality of participants.

19. One or more non-transitory storage media storing instructions which, when executed by one or more computing devices, cause performance of a method of managing multi-role activities in a physical room with multimedia communications, the method comprising:
receiving definitions of a plurality of application modes describing:
each of the plurality of application modes corresponding to an activity performed in the physical room by a plurality of participants and being associated with a set of roles and a set of rules,
one of the set of rules being related to multiple participants of the plurality of participants in multiple roles of the set of roles interacting with one another in the physical room,
each of the set of roles being associated with a distinct set of permissions or requirements under the set of rules;
selecting, for a specific plurality of participants, a specific application mode of the plurality of application modes, the specific application mode associated with a specific set of roles and a specific set of rules;
receiving, in real time, input data capturing a current state of at least a portion of the physical room from one or more of a plurality of types of input devices in the physical room, including a camera and a microphone,
the input data including one or more types of data produced by the one or more types of input devices;
determining whether an action can be inferred from the input data using natural language processing, video analysis, or other machine learning techniques; and
in response to determining that an action can be inferred from the input data:
identifying multiple actions simultaneously performed by multiple participants from the input data, including a first action performed by a first participant and a second action performed by a second participant;
determining the first participant being in a higher role than the second participant, inference of the first action being associated with a higher confidence score than an inference of the second action, or a first type of input device producing a first portion of the input data from which the first action is inferred being associated with a higher priority than a second type of input device producing a second portion of the input data from which the second action is inferred:
determining a goal of the first action using natural language processing, video analysis, or other machine learning techniques;
determining whether achieving the goal is permitted based on the role of the first participant and the specific set of rules; and
transmitting, in real time, output data related determining whether achieving the goal is permitted to one or more of a plurality of types of output devices in the physical room, including a screen and a speaker, in accordance with the specific set of rules,
the output data confirming the first action or requiring the second participant to wait as the first participant repeats the first action,
the output data including one or more types of data to be received by the one or more types of output devices.

20. (canceled)

21. The system of claim 1, further comprising the one or more input devices or output devices coupled with the processor.
